(19) United States
(12) Patent Application Publication
(10) Pub. No.: US 2006/0074624 A1
(43) Pub. Date: Apr. 6, 2006

(54) Sign language video presentation device , sign language video i/o device , and sign language interpretation system

(76) Inventor: Nozomu Sahashi, Osaka (JP)

Correspondence Address: KEATING & BENNETT, LLP, 8180 GREENSBORO DRIVE, SUITE 850, MCLEAN, VA, 22102, US

(21) Appl. No.: 10/527,912

(22) PCT Filed: Sep. 16, 2003
(86) PCT No.: PCT/JP03/11758

§ 371 Date: Sep. 27, 2005

(30) Foreign Application Priority Data
Sep. 17, 2002 (JP) 2002-269851

(51) Int. Cl. G06F 17/20

(52) U.S. Cl. 704/8

(57) ABSTRACT

A sign language interpretation assistance device includes a display device for displaying a sign language video, a fixing device for fixing the display device in front of the eyes of the deaf-mute person, and a videophone connection device for supplying the display device with a sign language video being received by a videophone terminal. The sign language video input/output device includes a sign language imaging camera for capturing the sign language of the deaf-mute person to the sign language video presentation device and a waist fixing device for fixing the sign language imaging camera at the waist of the deaf-mute person, such that the sign language of the deaf-mute person captured by the sign language imaging camera is provided to the video telephone terminal. A sign language interpretation system provides a sign language interpretation service when a deaf-mute person converses with a non-deaf-mute person by using the sign language video input/output device.

### BACKGROUND OF THE INVENTION

1. Field of the Invention

The present invention relates to a videophone sign language interpretation assistance device and a sign language interpretation system including the sign language interpretation assistance device used by a deaf-mute person when the deaf-mute person remotely obtains sign language interpretation by a sign language interpreter via a videophone, and in particular, the present invention relates to a videophone sign language interpretation assistance device and a sign language interpretation system including the same to be used when a deaf-mute person converses on the road with a non-deaf-mute person who is incapable of using sign language.

2. Description of the Related Art

A deaf-mute person who is hearing and speaking impaired wishing to communicate on the road with a non-deaf-mute person who is incapable of using sign language has to use communications in writing or find a person capable of using sign language. Fluent conversation is difficult when communicating in writing. Moreover, for communications using sign language, a very small number of non-deaf persons can use sign language. These problems present a high barrier in the social life of a deaf-mute person.

A conversation using sign language over a videophone is available at a practical level with the advancement of communications technologies. It is possible to provide a sign language interpretation service via a videophone.

FIG. 10 is a conceptual diagram showing a situation in which a deaf-mute person who is away from home converses with a non-deaf-mute person who is incapable of using sign language, via a sign language interpretation service using a prior art videophone terminal, such as a cellular phone, equipped with a videophone function. As shown in FIG. 10, a deaf-mute person A sets a videophone terminal 10 while watching a video display section 10a of the videophone terminal 10 such that his/her sign language is captured in an imaging section 10b. At the same time, the deaf-mute person A asks a non-deaf-mute person B, as a conversation partner, to wear a headset 10c for audio input/output of the videophone terminal 10, then calls a videophone terminal 20 of a sign language interpreter C of a sign language interpretation service. Before beginning sign language interpretation, the sign language interpreter C sets a videophone terminal 20 while watching a video display section 10a of the videophone terminal 20 such that his/her sign language will appear in an imaging section 20b, and wears his/her headset 20c for audio input/output.

While the sign language of the deaf-mute person A is not directly understood by the non-deaf-mute person B, the video of the sign language is captured by an imaging section 10b of the videophone terminal 10, transmitted to the videophone terminal 20 and displayed on the video display section 20a, such that the sign language interpreter C can translate the sign language of the deaf-mute person A into voice while watching the video and the voice of the sign language interpreter C is collected by the microphone of the headset 20c, transmitted to the videophone terminal 10, and output to the earphone of the headset 10c. The non-deaf-mute person B listens to the voice of the sign language interpreter C to understand the sign language of the deaf-mute person A.

While the voice of the non-deaf-mute person B is not directly heard by the deaf-mute person A, his/her voice is collected by the microphone of the headset 10c of the videophone terminal 10, transmitted to the videophone terminal 20, and output to the earphone of the headset 20c. The sign language interpreter C translates the voice of the non-deaf-mute person B into sign language, the sign language of the sign language interpreter is captured by the imaging section 20b and transmitted to the videophone terminal 10 and displayed on the display section 10a. The deaf-mute person A watches the sign language of the sign language interpreter C so as to understand the voice of the non-deaf-mute person.

In this manner, by using a videophone, the deaf-mute person A and the non-deaf-mute person B can communicate with each other by calling the sign language interpreter C, even when they are away from each other.

While an example has been described where the sign language interpreter uses the same type of videophone terminal of the cellular phone type as that used by the deaf-mute person and the non-deaf-mute person, a sign language interpretation center which provides a sign language interpretation service may be provided and a desktop-type videophone terminal may be used to provide a sign language interpretation service.

However, when the single videophone terminal is used by a deaf-mute person and a non-deaf-mute person to obtain a sign language interpretation service, the deaf-mute person must continually watch the display section of the videophone terminal while the sign language interpreter is translating the voice of the non-deaf-mute person into sign language, without watching the expressions or gestures of the non-deaf-mute person as a conversation partner at the same time. This makes fluent conversation difficult and presents a problem in that a deaf-mute person cannot adequately understand the intentions or feelings of a non-deaf-mute person.

Such a problem of the deaf-mute person's sight line occurs when sign language interpretation is provided, as well as in many situations in which the deaf-mute person is given an explanation via sign language.

For example, assume a situation in which a deaf-mute person is riding in a sightseeing bus. During an explanation via sign language by a guide, as soon as the guide draws attention of the passengers to the right (left) by using sign language when the bus is at an historic site, the deaf-mute person shifts his/her eyes from the sign language to the historic site, and fails to fully receive the explanation of the historic site.

Similarly, despite explanation with sign language on a sightseeing location or in an exhibition, a deaf-mute person cannot see the real object while listening to the explanation, such that he/she may not appreciate the scene or get the impression which should be given.

An unimpaired person can hear the explanation given such that he/she can shift his/her sight line. A deaf-mute person must keep watching the person performing sign language, and is thus, handicapped to a great extent.

### SUMMARY OF THE INVENTION

To overcome the problems described above, preferred embodiments of the present invention provide a videophone sign language interpretation assistance device and a sign language interpretation system using the same which enables a deaf-mute person to use a videophone to obtain sign language interpretation by a sign language interpreter while viewing the outer world by freely shifting his/her sight line.

According to a preferred embodiment of the present invention, a videophone sign language interpretation assistance device used by a deaf-mute person when the deaf-mute person remotely obtains sign language interpretation by a sign language interpreter in a conversation with a non-deaf-mute person by using a videophone includes display means fixed on the head of a deaf-mute person for displaying the video of a sign language interpreter received by a videophone terminal in front of the eyes of the deaf-mute person, while enabling the deaf-mute person to view the outer world including the expressions of the conversation partner, hand imaging means fixed at the waist of the deaf-mute person for capturing images of the hands of the deaf-mute person to acquire a sign language video, first communications means for receiving a video signal from the videophone terminal, supplying the video signal to the display means and transmitting a video signal acquired by the hand imaging means to the videophone terminal, audio input/output means for a non-deaf-mute person for inputting/outputting the voice of a non-deaf-mute person, and second communications means for receiving an audio signal from the videophone terminal, supplying the audio signal to the audio input/output means, and transmitting an audio signal acquired by the non-deaf-mute person audio input/output means to the videophone terminal, wherein the deaf-mute person can obtain sign language interpretation by a sign language interpreter while freely changing his/her sight line, orientation or position by using the display device and the hand imaging means, and the non-deaf-mute person can obtain voice translation by the sign language interpreter via the audio input/output means.

At least one of the first communications means and the second communications means preferably includes radio communications means for performing radio communications with the videophone terminal, and a deaf-mute person and a non-deaf-mute person can obtain sign language interpretation by a sign language interpreter while traveling freely.

According to another preferred embodiment of the present invention, a sign language interpretation system for providing sign language interpretation in a conversation between a deaf-mute person and a non-deaf-mute person in which the videophone sign language interpretation assistance device according to the preferred embodiment described above is connected to the videophone terminal of the deaf-mute person and the videophone terminal of the deaf-mute person and the videophone terminal of a sign language interpreter are interconnected, wherein the sign language interpretation system includes terminal connection means equipped with a sign language interpreter registration table in which the terminal number of the videophone terminal used by a sign language interpreter is registered, the terminal connection means including a function to accept a call from the videophone terminal of a deaf-mute person, a function to extract the terminal number of the videophone terminal of a sign language interpreter from the sign language interpreter registration table, and a function to call the videophone terminal of the sign language interpreter using the extracted terminal number of the sign language interpreter, and connection from the videophone terminal of the deaf-mute person to the terminal connection means automatically connects to the videophone terminal of the sign language interpreter.

Selection information for selecting a sign language interpreter is preferably registered in the sign language interpreter registration table, the terminal connection means preferably includes a function to acquire the conditions for selecting a sign language interpreter from the videophone terminal of a deaf-mute person and a function to extract the terminal number of a sign language interpreter who satisfies the acquired selection conditions for the sign language interpreter from the sign language interpreter registration table, and a desired sign language interpreter can be selected from the videophone terminal of the deaf-mute person.

The terminal connection means preferably includes a function to register a term in the term registration table via an operation from a videophone terminal, a function to select a term to be used from the terms registered in the term registration table via an operation from a videophone terminal, a function to generate a telop of the selected term, and a function to synthesize the generated telop onto a video to be transmitted to the opponent terminal so as to display, in a telop, on the videophone terminal of the opponent terminal a term that is difficult to explain with sign language during sign language interpretation or a word that is difficult to pronounce.

Since the sign language interpreter registration table includes an availability flag to register whether a registered sign language interpreter is available, and the connection means references an availability flag in the sign language interpreter registration table to extract the terminal number of an available sign language interpreter, it is possible to automatically select an available sign language interpreter, thereby eliminating useless calling and providing a more flexible and efficient sign language interpretation system.

Other features, elements, steps, characteristics and advantages of the present invention will become more apparent from the following detailed description of preferred embodiments with reference to the attached drawings.

### BRIEF DESCRIPTION OF THE DRAWINGS

FIG. 1 is a block diagram of a sign language video input/output device according to a preferred embodiment of the present invention;

FIG. 2 is a system block diagram of a sign language interpretation system according to a preferred embodiment of the present invention;

FIG. 3 is a processing flowchart of a controller in a sign language interpretation system according to a preferred embodiment of the present invention;

FIG. 4 shows an example of a sign language interpreter registration table;

FIG. 5 shows an example of a screen for prompting input of sign language interpreter selection conditions;

FIG. 6 shown an example of a screen for displaying list of sign language interpreter candidates;

FIG. 7 is a system block diagram of a sign language interpretation system according to another preferred embodiment of the present invention;

FIG. 8 shows an example of a connection table;

FIG. 9 is a processing flowchart of a controller in a sign language interpretation system according to another preferred embodiment of the present invention; and

FIG. 10 is a conceptual diagram showing a situation in which a sign language interpretation service is obtained by using a prior art videophone terminal.

### DETAILED DESCRIPTION OF PREFERRED EMBODIMENTS

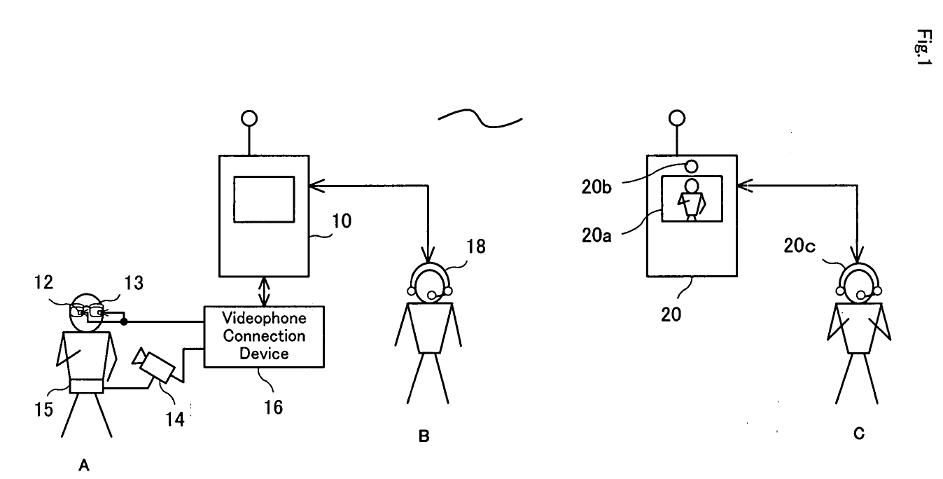

FIG. 1 is a block diagram of a sign language video input/output device according to a preferred embodiment of the present invention. This preferred embodiment shows a situation in which a deaf-mute person A who is away from home uses a videophone to call a sign language interpreter C in order to have a conversation with a non-deaf-mute person B who is incapable of using sign language.

In FIG. 1, numeral 10 represents a videophone terminal for sign language interpretation recipients (hereinafter referred to as a sign language interpretation recipients terminal) used by a deaf-mute person A or a non-deaf-mute person B in order to obtain a sign language interpretation service. Numeral 20 represents a videophone terminal for sign language interpreters (hereinafter referred to as a sign language interpreter terminal) used by a sign language interpreter.

The sign language interpretation recipients terminal 10 includes, as equipment for a deaf-mute person A, a display device 12 for displaying a sign language video, a fixture 13 for locating the display device 12 in front of the eyes of the deaf-mute person, a sign language imaging camera 14 for capturing images of the sign language of the deaf-mute person, a waist fixture 15 for fixing the sign language imaging camera 14 at the waist of the deaf-mute person, and a sign language video input/output device including the display device 12 and a videophone connection device 16 for connecting the sign language imaging camera 14 to the videophone terminal 10. The sign language interpretation recipients terminal 10 also includes, as equipment for a non-deaf-mute person B, a headset for audio input/output 18.

The sign language interpreter terminal 20 includes a video display section 20a for displaying a video, an imaging section 20b for capturing images of the sign language of a sign language interpreter, and a headset for audio input/output 20c.

The display device 12 is defined, for example, by a small-sized liquid crystal display having a sufficient resolution to display a sign language video. The display device 12 magnifies a video such that a deaf-mute person can recognize the sign language displayed with the fixture 13 attached. On the surface of the display device 12, a convex lens is attached such that sign language displayed on the display device 12 is brought into focus while the deaf-mute person is viewing the outer world, such as the conversation partner and the scenery. This enables the deaf-mute person to easily recognize the sign language displayed on the display device 12 while viewing the outer world.

The fixture 13 includes a spectacle frame structure which can be fixed to the ears and nose of a deaf-mute person. Near the frame in front of the eyes of the deaf-mute person, the display device 12 is attached for viewing sign language without impairing the sight of the outer world. While the display device 12 is provided in a lower left location in front of the eyes of the deaf-mute person in this example, the display device 12 may be provided anywhere as long as it does not impair the sight of the outer world.

While the display devices 12 are provided on the same right and left locations of the fixture 13 so as to provide more clear recognition of the displayed sign language in this example, the display unit 12 may be provided on either side of the fixture 13 as long as the deaf-mute person can easily recognize the displayed sign language.

The fixture 13 is used to locate the display device 12 in front of the eyes of the deaf-mute person, such that the display device 12 may be fixed to a hollow frame. Or, a transparent plate may be provided in a frame and the display unit 12 may be adhered to the transparent plate. In case the deaf-mute person has myopia, hyperopia, astigmatism, or presbyopia, and thus, needs a corrective lens, a corrective lens may be provided in a frame and the display device 12 may be adhered to the corrective lens.

The sign language imaging camera, 14 such as a small-sized CCD camera, is fixed to the waist fixture 15. The sign language imaging camera 14 is set to an angle of view that is wide enough to capture images of the sign language of the deaf-mute person while it is fixed to the waist fixture 15.

The waist fixture 15 is, for example, a belt to be fixed at the waist of a deaf-mute person. Any waist fixture may be used which includes a buckle having an arm for fixing the sign language imaging camera 14 to enable the sign language imaging camera 14 to be set in an orientation in which the sign language of the deaf-mute person can be captured. This makes it possible to stably capture the sign language of the deaf-mute person by using the sign language imaging camera 14, even when the deaf-mute person changes his/her position or orientation.

The videophone connection device 16 is a device which connects the display device 12 and the sign language imaging camera 14 with the external device connecting terminal of the videophone terminal 10. The videophone connection device 16 supplies a video signal that is received by the videophone terminal 10 to the display device 12, and supplies a video signal from the sign language imaging camera 14 to the videophone terminal 10. Thus, the display device 12 functions as an external video display device of the videophone terminal 10 and the sign language imaging camera 14 functions as an external video input device of the videophone terminal 10.

Next, the operation for a conversation between the deaf-mute person A and the non-deaf-mute person B via the sign language interpreter C by using such a sign language video input/output device will be described.

The deaf-mute person A wears the fixture 13 and the waist fixture 15, and connects the videophone connection device 16 to the external device connection terminal of the sign language interpretation recipient terminal 10.

The non-deaf-mute person B wears the headset 18 and connects the headset 18 to the audio input/output terminal of the sign language interpretation recipient terminal 10.

Next, the deaf-mute person A or the non-deaf-mute person B calls the sign language interpreter terminal 20 used by a sign language interpreter from the sign language interpretation recipient terminal 10.

The sign language interpreter C accepts the request for sign language interpretation, sets the sign language interpreter videophone terminal 20 while watching the video display section 20a such that his/her sign language will appear in the imaging section 20b, wears the headset 20a, and connects it to the audio input/output terminal of the sign language interpreter videophone terminal 20.

When the deaf-mute person A performs sign language, video of the sign language is captured by the sign language imaging camera 14, transmitted from the sign language interpretation recipient terminal 10 to the sign language interpreter terminal 20, and displayed in the video display section 20a. The sign language interpreter C watches the sign language of the deaf-mute person A displayed in the video display section 20a and translates the sign language into a voice. The translated voice by the sign language interpreter C is collected by the microphone of the headset 20c, transmitted from the sign language interpreter terminal 20 to the sign language interpretation recipient terminal 10, and output to the earphone of the headset 18. The non-deaf-mute person B listens to the voice translated by the sign language interpreter C to understand the sign language of the deaf-mute person A.

On the other hand, the voice of the non-deaf-mute person B is captured by the microphone of the headset 18, transmitted from the sign language interpretation recipient terminal 10 to the sign language interpreter terminal 20, and output to the earphone of the headset 20c. The sign language interpreter C listens to the voice of the non-deaf-mute person B and translates it into sign language. The sign language translated by the sign language interpreter C is captured by the imaging section 20b, transmitted from the sign language interpreter terminal 20 to the sign language interpretation recipient terminal 10, and displayed on the display device 12. The deaf-mute person A watches the sign language translated by the sign language interpreter C to understand the voice of the non-deaf-mute person B.

The sign language translated by the sign language interpreter C is displayed on the display device 12 fixed by the fixture 13 in front of the eyes of the deaf-mute person A. Thus, the deaf-mute person A can converse with the non-deaf-mute person B while freely shifting his/her sight line. The deaf-mute person A can watch the sign language translated into by the sign language interpreter C while observing the expressions of the non-deaf-mute person B or watch the sign language translated by the sign language interpreter C while observing an object that is a target of conversation with the non-deaf-mute person B. This provides a quick conversation and deeper understanding of the partner's intention.

The sign language of the deaf-mute person A is captured by the sign language imaging camera 14 fixed with the waist fixture 15, and is thus, captured stably even when the deaf-mute person A changes his/her position or orientation. This provides the ultimate freedom of the movement and behavior of the deaf-mute person A.

While the fixture 13 for fixing the display device 12 in front of the eyes of a deaf-mute person uses a spectacle frame structure in the above-described preferred embodiment, the fixture 13 may include a hair band fixed on the head equipped with an arm for supporting the display device 12, or may have any structure as long as it can fix the display device 12 in front of the eyes of the deaf-mute person.

While the sign language imaging camera 14 includes the waist fixture 15 fixed at the waist of the deaf-mute person in the above-described preferred embodiment, the sign language imaging camera 14 may use any type of fixing means as long as it can capture the sign language of the deaf-mute person and provides the same effect and advantages of the present invention.

While the videophone connection device 16 connects the display device 12 and the sign language imaging device 14 with the external device connecting terminal of the videophone terminal 10 via wires in the above-described preferred embodiment, a radio communications device for wirelessly transmitting/receiving a video signal may be provided on each of the external device connecting terminal of the videophone terminal 10, the fixture 13 and the waist fixture 15. This eliminates the need for cabling the videophone terminal 10, the fixture 13, and the waist fixture 15, which greatly facilitates handling.

If the videophone terminal 10 includes a wireless interface conforming to a Standard such as Bluetooth® for communicating with an external device, a communications device conforming to the same Standard should be provided on each of the fixture 13 and the waist fixture 15. By doing so, it is possible to communicate a video signal without physically connecting anything to the videophone terminal 10 as long as the communications devices provided on the fixture 13 and the waist fixture 15 are within the service area of the wireless interface of the videophone terminal 10, which adds to the ease of handling.

A radio communications device for communicating an audio signal by radio may also be provided on the headset 18 for non-deaf-mute persons to communicate with the sign language interpretation recipient terminal 10 in a cableless fashion. In this situation, an audio input/output channel may be provided on the videophone connection device 16 to perform audio communications as well as video signal communications. This enables the non-deaf-mute person B to move freely as long as he/she is within the service area of the radio communications device.

As mentioned above, if the videophone terminal 10 includes a wireless interface conforming to a Standard to communicate with an external device such as Bluetooth®, a communications device of the same Standard should be used on the headset 18. While audio input/output uses a headset for the non-deaf-mute person B also in the above-described preferred embodiment, the non-deaf-mute person B does not use sign language such that he/she may use a hand microphone and an external loudspeaker. For a videophone terminal of the cellular phone type, he/she may directly hold the main unit with his/her hands to perform audio communications with the sign language interpreter C.

While the above preferred embodiment describes a videophone terminal of the telephone type, especially a videophone terminal of a cellular phone type, the present invention is not limited thereto, and a videophone terminal of the IP type to connect to the internet may be used.

While the above preferred embodiment describes a sign language video input/output device including both a display device 12 for displaying a sign language video and a sign language imaging camera 14 for capturing sign language, a sign language video presentation device including a display device 12 for displaying sign language video, a fixture 13 for fixing the display device 12 in front of the eyes of a deaf-mute person, and a videophone connection device 16 for supplying a sign language video being received by a videophone terminal 10 to the display device 12 may enable a deaf-mute person to receive an explanation by sign language via a videophone while viewing the outer world by freely shifting his/her sight line.

It is not necessary for a sign language video to be received by a videophone, and a dedicated video signal receiver may be used instead. For example, a transmitter for transmitting a sign language video explanation in the sightseeing guidance or exhibition on a sightseeing spot may be provided and the sign language video may be received by a sign language video presentation device. By doing so, similar to audio guidance or explanation for a non-deaf-mute person, a deaf-mute person receives guidance or explanation by sign language while freely shifting his/her sight line. Thus, a deaf-mute person can enjoy sightseeing or a study tour, in a similar manner as a non-deaf-mute person.

Next, a sign language interpretation system will be described which enables selection of a sign language interpreter satisfying the object of a conversation where a deaf-mute person converses with a non-deaf-mute person by using a sign language video input/output device according to a preferred embodiment of the present invention.

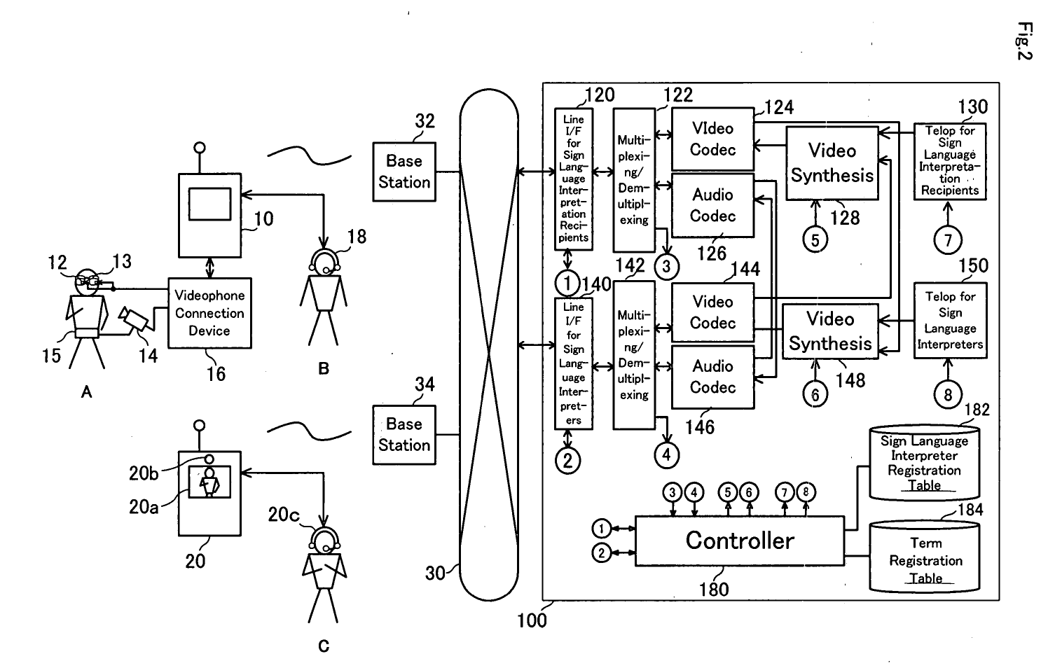

FIG. 2 is a system block diagram of a sign language interpretation system according to a preferred embodiment of the present invention. In this preferred embodiment, a deaf-mute person and a non-deaf-mute person use the sign language video input/output device to propose a sign language interpretation service from a single videophone terminal.

In FIG. 2, numeral 100 represents a sign language interpretation system installed in a sign language interpretation center which provides a sign language interpretation service. The sign language interpretation system 100 interconnects, via a public telephone line 30, a sign language interpretation recipient terminal 10 used by a deaf-mute person A and a non-deaf-mute person B and a sign language interpreter terminal 20 used by a sign language interpreter C to provide a sign language interpretation service in a conversation between the deaf-mute person and the non-deaf-mute person. In this preferred embodiment, both the sign language interpretation recipient terminal 10 and the sign language interpreter terminal 20 are videophone terminals of the telephone type connected to a public telephone line, and in particular, wireless videophone terminals of the cellular phone type which can be carried when traveling.

Such a videophone terminal connected to a public line may be an ISDN videophone terminal based on ITU-T recommendation H.320, the present invention is not limited thereto and may use a videophone terminal which operates according to a unique protocol.

The sign language interpretation system 100 includes a line interface for the sign language interpretation recipient terminal to connect to a sign language interpretation recipient terminal (hereinafter referred to as an I/F) 120 and a line I/F for the sign language interpreter terminal 140 to connect to a sign language interpreter terminal. To each I/F are connected a multiplexer/demultiplexer 122, 142 for multiplexing/demultiplexing a video signal, an audio signal or a data signal, a video CODEC (coder/decoder) 124, 144 for compressing/expanding a video signal, and an audio CODEC 126, 146 for compressing/expanding an audio signal. Each line I/F, each multiplexer/demultiplexer, and each video CODEC or each audio CODEC perform call control, streaming control compression/expansion of a video/audio signal in accordance with a protocol used by each terminal.

To the video input of the video CODEC for the sign language interpretation recipient terminal 124, a video synthesizer 128 is connected for synthesizing the video output of the video CODEC for the sign language interpreter terminal 144 and the output of the telop memory for the sign language interpretation recipient terminal 130.

To the audio input of the audio CODEC for the sign language interpretation recipient 126, the audio output is connected of the audio CODEC for the sign language interpreter terminal 146.

To the video input of the video CODEC for the sign language interpreter terminal 144, a video synthesizer 148 is connected for synthesizing the video output of the video CODEC for the sign language interpretation recipient terminal 124 and the output of the telop memory for the n sign language interpreter terminal 150.

To the audio input of the audio CODEC for the sign language interpreter person terminal 146, the audio output is connected of the audio CODEC for the sign language interpretation recipient terminal 126.

The sign language interpretation system 100 is provided with a sign language interpreter registration table 182 in which the terminal number of a terminal for sign language interpreters used by a sign language interpreter is registered, and includes a controller 180 connected to each of the line I/Fs 120, 140, multiplexers/demultiplexers 122, 142, video synthesizers 128, 148, and telop memories 132, 152. The sign language interpretation system 100 provides a function to connect a sign language interpretation recipient terminal and a sign language interpreter terminal by way of a function to accept a call from a sign language interpretation recipient terminal, a function to extract the terminal number of a sign language interpreter from the sign language interpreter registration table 182, a function to call the extracted terminal number, and also provides a function to switch a video/audio synthesis method used by video/audio synthesizers and a function to generate a telop and transmit the telop to a telop memory.

The contents of each telop memory 132, 152 are set from the controller 180. When a sign language interpretation service with a videophone is established, a message for each terminal is set to each telop memory 132, 152, and a command is issued to each video synthesizer 128, 148 to select a signal of each telop memory 132, 152. Thus, a necessary message is transmitted to each terminal and a sign language interpretation connection is established.

If there is a term which is difficult to explain using sign language or a term which is difficult to pronounce in a sign language interpretation service with a videophone, these terms may be registered in advance in the term registration table 184 of the controller 180 in association with the number of the dial pad on each terminal. By doing so, it is possible to detect a press of a key on the dial pad on each terminal during a sign language interpretation service, extract the term corresponding to the number of the dial pad pressed from the term registration table, generate a text telop, and set the text telop to each telop memory, thereby displaying the term on each terminal.

With this configuration, a term which is difficult to explain using sign language or a term which is difficult to pronounce is transmitted to the other party via a text telop, thus, providing a quicker and more to-the-point sign language interpretation service.

Next, a processing flow of the controller 180 for providing a sign language interpretation service is shown.

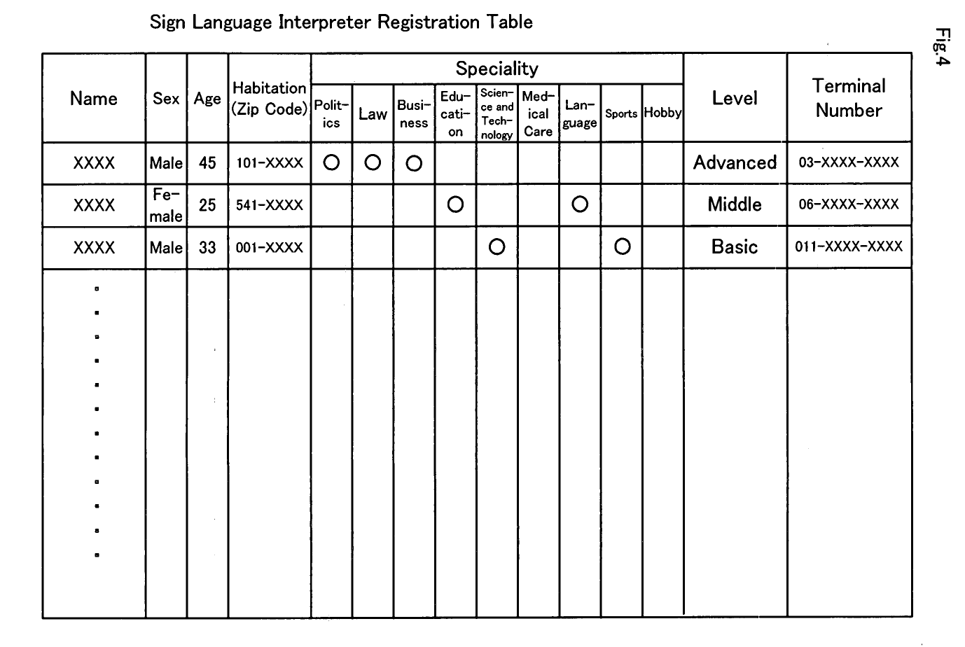

Prior to processing, information to select a sign language interpreter and the terminal number of a terminal used by each sign language interpreter are registered in the sign language interpreter registration table 182 of the controller 180 from an appropriate terminal (not shown). FIG. 4 shows an example of registration item to be registered in the sign language interpreter registration table 182. The information to select a sign language interpreter refers to information used by the user to select a desired sign language interpreter, which includes a sex, an age, a habitation, a specialty, and the level of sign language interpretation. The habitation assumes a situation in which the user wants a person who has geographic knowledge on a specific area and, in this example, a ZIP code is used to specify an area. The specialty assumes a situation in which, when the conversation pertains to a specific field, the user wants a person who has expert knowledge of the field or is familiar with the topics in the field. In this example, the fields a sign language interpreter is familiar with are classified into several categories to be registered, such as politics, law, business, education, science and technology, medical care, language, sports, and hobby. The specialties are diverse, such that they may be registered hierarchically and searched through at a level desired by the user when selected.

In addition, qualifications of each sign language interpreter may be registered in advance for the user to select a qualified person as a sign language interpreter.

The terminal number to be registered is the telephone number of the terminal, because in this example a videophone terminal is connected to a public telephone line.

In the sign language interpreter registration table 182, an availability flag is provided to indicate whether sign language interpretation can be accepted. A registered sign language interpreter can call the sign language interpretation center from his/her terminal and enter a command by using a dial pad to set/reset the availability flag. Thus, a sign language interpreter registered in the sign language interpreter registration table can set the availability flag only when he/she is available for sign language interpretation, thereby eliminating useless calling and enabling the user to select an available sign language interpreter without delay.

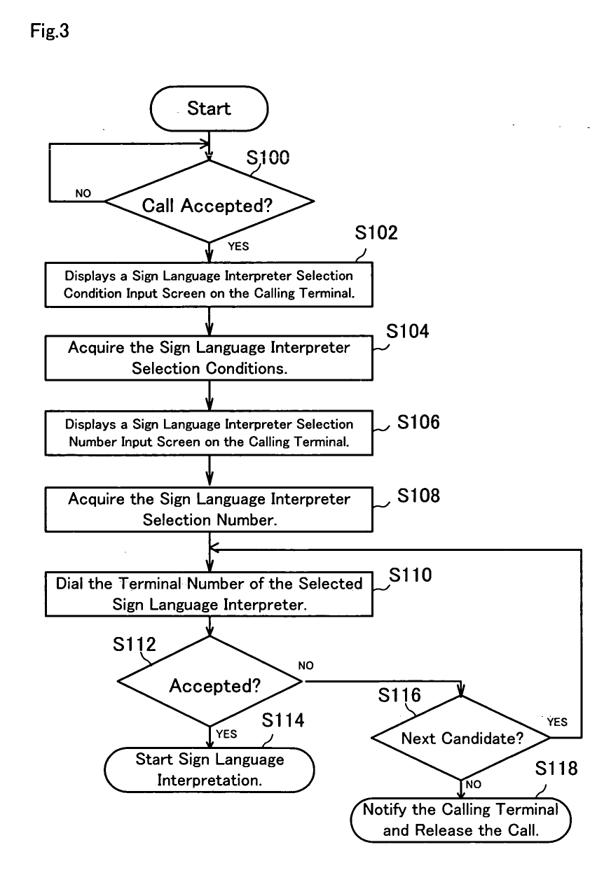

FIG. 3 shows a processing flowchart of the controller 180. In the sign language interpretation system 100, a sign language interpretation recipient terminal makes a call to a telephone number on the line I/F of the sign language interpretation recipient terminal to call a sign language interpreter terminal, thereby establishing a videophone connection via sign language interpretation.

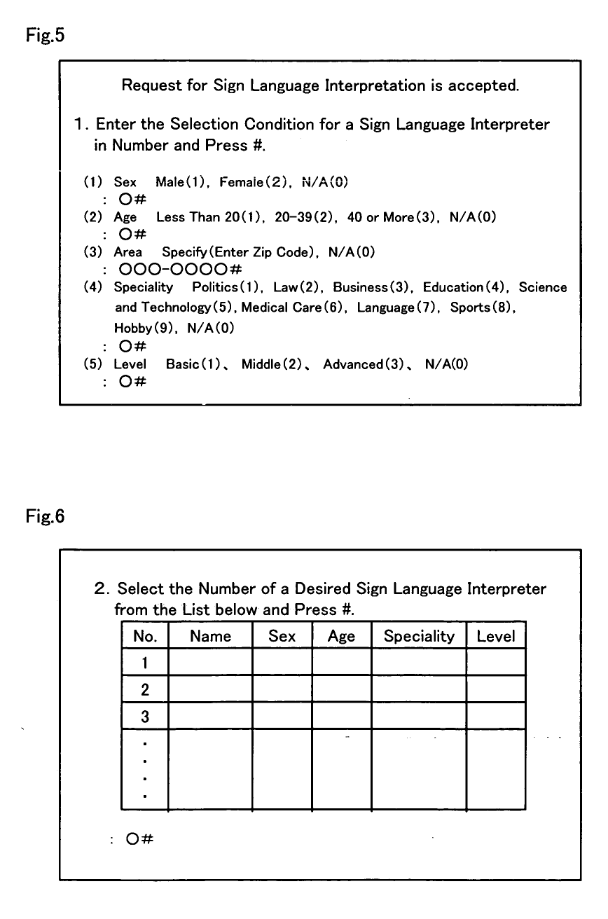

As shown in FIG. 3, it is first detected that the line I/F for the sign language interpretation recipient terminal 120 is called (S100). Next, the calling terminal displays a screen to prompt input of the selection conditions for a sign language interpreter shown in FIG. 5 (S102). The sign language interpreter selection conditions input by the caller are acquired (S104). The sign language interpreter selection conditions input by the caller are sex, age bracket, area, specialty and sign language level. A corresponding sign language interpreter is selected based on the sex, age, habitation, specialty, and sign language level registered in the sign language interpreter registration table. The area is specified by a ZIP code and a sign language interpreter is selected starting with the habitation closest to the specified area. For any selections, if it is not necessary to specify a condition, N/A may be selected.

Next, a sign language interpreter with availability flag set is selected from among the sign language interpreters satisfying the selection conditions acquired referring to the sign language interpreter registration table 182. The calling terminal displays a list of sign language interpreter candidates shown in FIG. 6 to prompt input of the selection number of a desired sign language interpreter (S106). The selection number of the sign language interpreter input by the caller is acquired (S108) and the terminal number of the selected sign language interpreter is extracted from the sign language interpreter registration table and the terminal is called (S110). When the sign language interpreter terminal has accepted the call (S112), a sign language interpretation service starts (S114).

If the sign language interpreter terminal selected in S112 does not accept the call, whether a next candidate is available is determined (S116). If a next candidate is available, execution returns to S110 and the procedure is repeated. Otherwise the calling terminal is notified as such and the call is released (S118).

While if the selected sign language interpreter terminal does not accept the call, the caller is notified as such and the call is released in the above-described preferred embodiment, a sign language interpretation reservation table to register a calling terminal number may be provided and the caller may be notified on a later response from the selected sign language interpreter to set a sign language interpretation service.

While the sign language interpretation system 100 includes a line I/F, a multiplexer/demultiplexer, a video CODEC, an audio CODEC, a video synthesizer, an audio synthesizer and a controller in the above-described preferred embodiment, these components need not be implemented by individual hardware (H/W), and the function of each component may be implemented by software running on a computer.

While the sign language interpreter terminal 20, is located outside the sign language interpretation center and called from the sign language interpretation center over a public telephone line to provide a sign language interpretation service in the above-described preferred embodiment, the present invention is not limited thereto, a portion or all of the sign language interpreters may be provided in the sign language interpretation center to provide a sign language interpretation service from the sign language interpretation center.

In the above-described preferred embodiment, a sign language interpreter can provide sign language interpretation services anywhere he/she may be, as long as he/she has a terminal which can be connected to a public telephone line. Thus, the sign language interpreter can provide a sign language interpretation service by using the availability flag to make efficient use of free time. By doing so, it is possible to stably operate a sign language interpretation service. In particular, the number of volunteer sign language interpreters is increasing nowadays. A volunteer who is available only irregularly can provide a sign language interpretation service by taking advantage of limited free time.

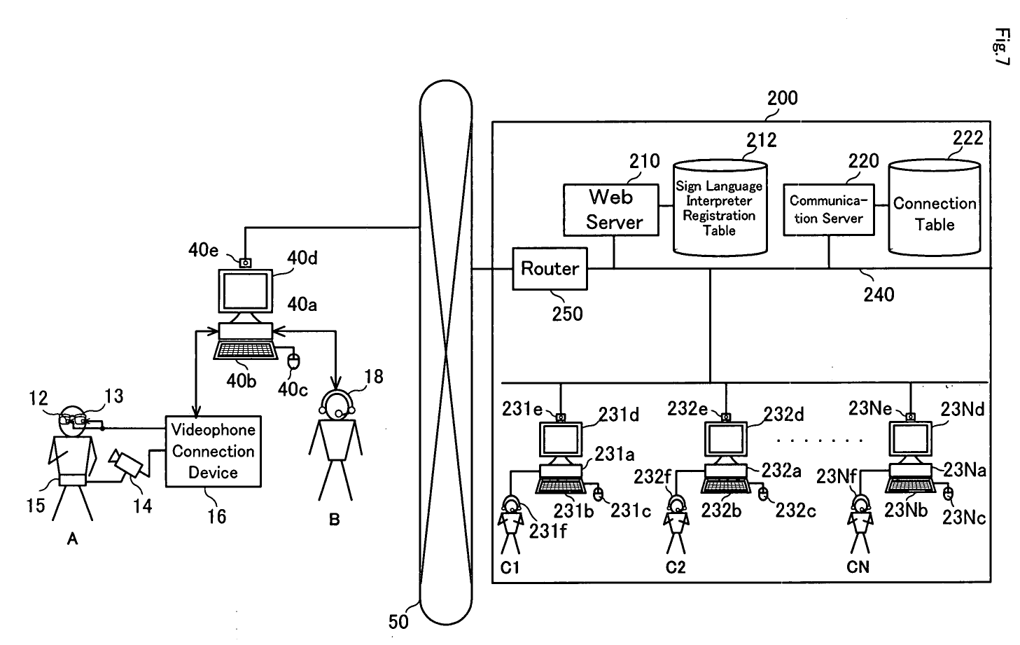

FIG. 7 is a system block diagram of a sign language interpretation system according to another preferred embodiment of the present invention. This preferred embodiment shows a system configuration example assuming that each terminal used by sign language interpretation recipient and a sign language interpreter is an IP (Internet Protocol) type videophone terminal to connect to the internet equipped with a web browser.

In FIG. 7, numeral 200 represents a sign language interpretation system installed in a sign language interpretation center to provide a sign language interpretation service. The sign language interpretation system 200 connects a sign language interpretation recipient terminal 40 used by a deaf-mute person and a non-deaf-mute person and any of the sign language interpreter terminals used by a sign language interpreter 231, 232, . . . via the internet 50 in order to provide a sign language interpretation service for the conversation between the deaf-mute person and the non-deaf-mute person.

While each of the sign language interpretation recipient terminal 40 and the sign language interpreter terminals 231, 232, . . . includes a general-purpose processing device (a) such as a personal computer having a video input I/F function, an audio input/output I/F function and a network connection function, the processing device equipped with a keyboard (b) and a mouse (c) for input of information as well as a display (d) for displaying a web page screen presented by a web server 210 and a videophone screen supplied by a communications server 220, a television camera (e) for imaging the sign language of a sign language interpreter, and a headset (f) for performing audio input/output for the sign language interpreter, the processing device has IP videophone software and a web browser installed in this example, a dedicated videophone terminal may be used instead.

The videophone terminal connected to the internet may be an IP videophone terminal based on ITU-T recommendation H.323. However, the present invention is not limited thereto, and may use a videophone terminal which operates according to a unique protocol.

The Internet may be a wireless LAN. The videophone terminal may be a cellular phone or a portable terminal equipped with a videophone function and also including a web access function.

The sign language interpretation system 200 includes a communications server 220 including a connection table 222 for setting the terminal addresses of a sign language interpretation recipient terminal, a sign language interpreter terminal and a function to interconnect the terminals registered in the connection table 222 and synthesize a video and an audio received from each terminal and transmit the synthesized video and audio to each terminal, a web server 210 including a sign language interpreter registration table 212 for registering the selection information, a terminal address, an availability flag of a sign language interpreter as mentioned earlier, and a function to select a desired sign language interpreter based on an access from a calling terminal by using a web browser and set the calling terminal and sign language interpreter terminal in the connection table 222 of the communication server 220, a router 250 for connecting the web server 210 and the communications server 220 to the internet, and a plurality of sign language interpreter terminals 231, 232, . . . , 23N connected to the communications server 220 via a network.

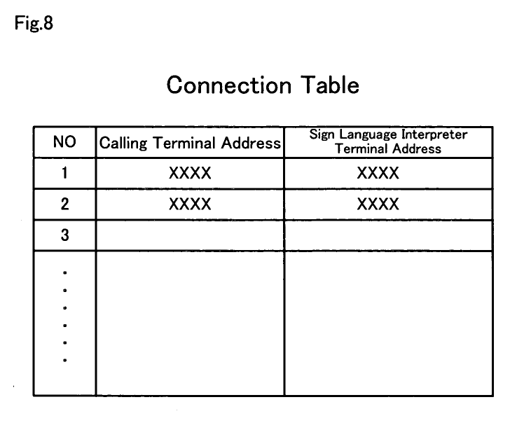

FIG. 8 shows an example of a connection table 222. As shown in FIG. 8, the terminal address of a calling terminal and the terminal address of a sign language interpreter terminal are registered as a set in the connection table 222. This provides a single sign language interpretation service. The connection table 222 is designed to register a plurality of such terminal address sets depending on the throughput of the communications server 220, thereby simultaneously providing a plurality of sign language interpretation services.

While the terminal address registered in the connection table 222 is preferably an address on the internet and is generally an IP address, the present invention is not limited thereto. For example, a name given by a directory server may be used.

The communications server 220 performs packet communications using a predetermined protocol with the sign language interpretation recipient terminal and sign language interpreter terminal set to the connection table 222 and provides, by way of software processing, the functions similar to those provided by a multiplexer/demultiplexer 122, 142, a video CODEC 124, 144, an audio CODEC 126, 146, a video synthesizer 128, 148, in the above-described sign language interpretation system 100.

With this configuration, prescribed videos and audios are communicated between a sign language interpretation recipient terminal and a sign language interpreter terminal, and a sign language interpretation service is established for the conversation between the deaf-mute person and the non-deaf-mute person.

While the sign language interpretation system 100 uses the controller 180 and the telop memories 132, 152 to extract a term registered in the term registration table 184 during a sign language interpretation service based on an instruction from a terminal and displays the term as a telop on the terminal, the same function may be provided by way of software processing by the communications server 220 in this preferred embodiment also. A term specified by each terminal may be displayed as a popup message on the other terminal by way of the web server 210. Or, a telop memory may be provided in the communications server 220 so that a term specified by each terminal via web browser will be written into the telop memory via the web server 210 and displayed as a text telop on each terminal.

While the sign language interpretation system 100 uses the controller 180 to interconnect a sign language interpretation recipient terminal and a sign language interpreter terminal, the connection procedure is made by the web server 210 in this preferred embodiment because each terminal has a web access function.

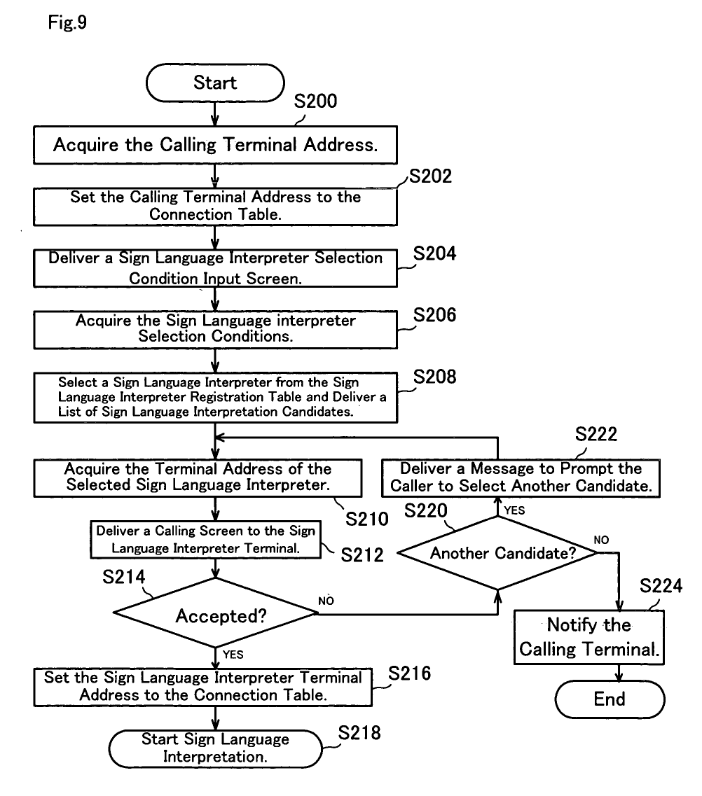

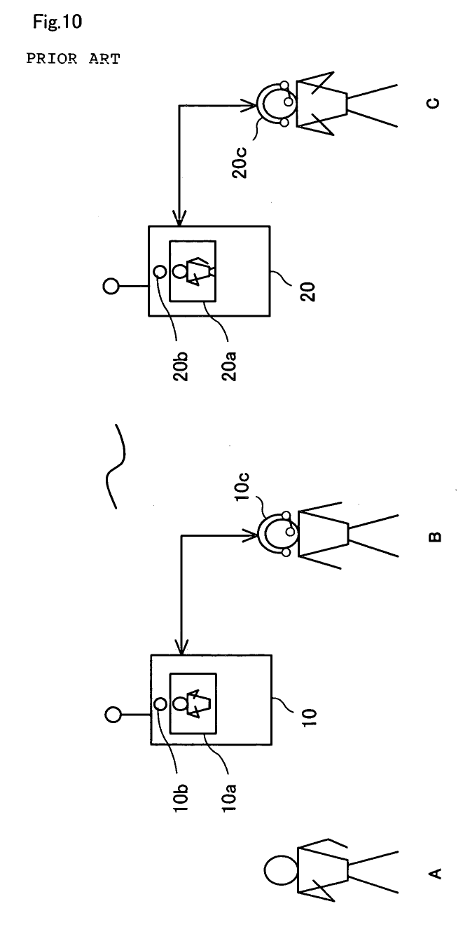

FIG. 9 is a processing flowchart of a connection procedure by the web server 210. A sign language interpretation recipient wishing to receive a sign language interpretation service accesses the web server 210 in the sign language interpretation center by using a web browser to log in from a sign language interpretation recipient terminal, which begins the acceptance of the sign language interpretation service.

As shown in FIG. 9, the web server 210 first acquires the terminal address of a caller (S200) and sets the terminal address to the connection table 222 (S202). Next, the web server delivers a screen to prompt input of the selection conditions for a sign language interpreter similar to that shown in FIG. 5 to the calling terminal (S204). The sign language interpreter selection conditions input by the caller are acquired (S206).

Next, a sign language interpreter with the availability flag set is selected from among the sign language interpreters satisfying the selection conditions acquired from the sign language interpreter registration table 212. The web server 210 delivers a list of sign language interpreter candidates similar to that shown in FIG. 6 to the calling terminal to prompt input of the selection number of a desired sign language interpreter (S208). The selection number of the sign language interpreter input by the caller is acquired and the terminal address of the selected sign language interpreter is acquired from the sign language interpreter registration table 212 (S210). Based on the acquired terminal address of the sign language interpreter, the web server 210 delivers a calling screen to the sign language interpreter terminal (S212). If the call is accepted by the sign language interpreter (S214), the terminal address of the sign language interpreter is set to the connection table 222 (S216) and the sign language interpretation service starts (S218).

If the sign language interpreter terminal does not accept the call in S214, whether a next candidate is available is determined (S220). If a next candidate is available, the web server delivers a message to prompt the caller to select another candidate (S222) to the calling terminal, then execution returns to S210. If another candidate is not found, the web server notifies the calling terminal as such (S224) and the call is released.

While if the selected sign language interpreter terminal does not accept the call, the caller is notified and the call is released in the above-described preferred embodiment, a sign language interpretation reservation table to register a calling terminal address may be provided and the caller may be notified on a later response from the selected sign language interpreter to set a videophone conversation.

While the sign language interpreter terminal is preferably located in the sign language interpretation system 200 of the sign language interpretation center in the above-described preferred embodiment, the present invention is not limited thereto, and some or all of the sign language interpreter terminals may be provided outside the sign language interpretation center and connected via the Internet.

In the above-described preferred embodiments, the configuration of the sign language interpretation system has been described for a situation in which a videophone terminal used by a sign language interpretation recipient or a sign language interpreter is a telephone-type videophone terminal connected to a public telephone line, and a situation in which the videophone terminal is an IP-type videophone terminal connected to the internet, the telephone-type videophone terminal and the IP-type videophone terminal can communicate with each other by arranging a gateway to perform protocol conversion therebetween. A sign language interpretation system conforming to one protocol may be provided via the gateway to support a videophone terminal which conforms to the other protocol.

In this manner, the sign language interpretation system enables the user to enjoy or provide sign language interpretation services anywhere he/she may be, as long as he/she has a terminal which can be connected to a public telephone line or the Internet. A sign language interpreter does not have to visit a sign language interpretation center, but rather, can present a sign language interpretation from his/her home or a facility or site where a videophone terminal is located, or provide a sign language interpretation service by using a cellular phone or a portable terminal equipped with a videophone function.

A person with the ability of sign language interpretation may wish to register in the sign language interpreter registration table in the sign language interpretation center in order to provide a sign language interpretation service anytime that it is convenient for him/her. From the viewpoint of the operation of the sign language interpretation center, it is not necessary to have sign language interpreters at the center. This enables efficient operation of the sign language interpretation center both in terms of time and costs. In particular, the number of volunteer sign language interpreters is increasing nowadays. The sign language interpretation service can be provided from a sign language interpreter's home, which facilitates reservation of a sign language interpreter.

As mentioned above, according to preferred embodiments of the present invention, a deaf-mute person can receive an explanation by sign language while viewing the outer world by freely shifting his/her sight line.

While the present invention has been described with respect to preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

1-9. (canceled)

10. A videophone sign language interpretation assistance device used by a deaf-mute person when the deaf-mute person remotely obtains sign language interpretation by a sign language interpreter in a conversation with a non-deaf-mute person by using a videophone, said videophone sign language interpretation assistance device comprising:
display means fixed on the head of a deaf-mute person for displaying a video of a sign language interpreter received by a videophone terminal in front of the eyes of the deaf-mute person while enabling the deaf-mute person to view the outer world including the expression of the conversation partner;
hand imaging means fixed at the waist of said deaf-mute person for capturing images of the hands of the deaf-mute person to acquire a sign language video;
first communications means for receiving a video signal from said videophone terminal, supplying the video signal to said display means and transmitting a video signal acquired by said hand imaging means to said videophone terminal;
audio input/output means for non-deaf-mute person for inputting/outputting the voice of a non-deaf-mute person; and
second communications means for receiving an audio signal from said videophone terminal, supplying the audio signal to said non-deaf-mute person audio input/output means and transmitting an audio signal acquired by said non-deaf-mute person audio input/output means to said videophone terminal; wherein
the deaf-mute person obtains sign language interpretation by a sign language interpreter while freely changing his/her sight line, orientation or position by using said display device and said hand imaging means and such that the non-deaf-mute person can obtain voice translation by the sign language interpreter by using said audio input/output means.

11. The videophone sign language interpretation assistance device according to claim 10, wherein at least one of said first communications means and said second communications means includes radio communications means for performing radio communications with said videophone terminal such that both of the deaf-mute person and the non-deaf-mute person obtain sign language interpretation by a sign language interpreter while traveling freely.

12. A sign language interpretation system for providing sign language interpretation in a conversation between a deaf-mute person and a non-deaf-mute person where the videophone sign language interpretation assistance device according to claim 10 is connected to the videophone terminal of the deaf-mute person and the videophone terminal of said deaf-mute person and the videophone terminal of a sign language interpreter are interconnected, wherein said sign language interpretation system comprises terminal connection means including a sign language interpreter registration table in which the terminal number of the videophone terminal used by a sign language interpreter is registered, said terminal connection means including a function to accept a call from the videophone terminal of a deaf-mute person, a function to extract the terminal number of the videophone terminal of a sign language interpreter from the sign language interpreter registration table, and a function to call the videophone terminal of the sign language interpreter by using the extracted terminal number of the sign language interpreter, and such that connection from the videophone terminal of the deaf-mute person to said terminal connection means automatically connects to the videophone terminal of the sign language interpreter.

13. The sign language interpretation system according claim 12, wherein selection information for selecting a sign language interpreter is registered in said sign language interpreter registration table;
said terminal connection means includes a function to acquire the conditions for selecting a sign language interpreter from the videophone terminal of a deaf-mute person and a function to extract the terminal number of a sign language interpreter who satisfies said acquired selection conditions for the sign language interpreter from said sign language interpreter registration table; and
a desired sign language interpreter can be selected from the videophone terminal of the deaf-mute person.

14. The sign language interpretation system according to claim 12, wherein said sign language interpretation system includes a term registration table for registering a term used during sign language interpretation; and
said terminal connection means includes a function to register a term in said term registration table via operation from a videophone terminal, a feature to select a term to be used from the terms registered in said term registration table by way of operation from a videophone terminal, a function to generate a telop of said selected term, and a function to synthesize said generated telop onto a video to be transmitted to the opponent party so as to display, in a telop, on the videophone terminal of the opponent party a term that is difficult to explain with sign language during sign language interpretation or a word that is difficult to pronounce.
